(19) United States
(12) Patent Application Publication
(10) Pub. No.: US 2025/0239929 A1
(43) Pub. Date: Jul. 24, 2025

(54) POWER CIRCUIT INCLUDING VOLTAGE CONVERSION CIRCUIT AND CURRENT SENSING CIRCUIT AND OPERATING METHOD OF POWER CIRCUIT

(71) Applicant: Samsung Electronics Co., Ltd., Suwon-si (KR)

(72) Inventors: Hongseok Shin, Suwon-si (KR); Dongyeon Kwag, Suwon-si (KR); Yongjin Kwon, Suwon-si (KR); Jisoo Chang, Suwon-si (KR); Hyeungjoon Cha, Suwon-si (KR); Daehoon Han, Suwon-si (KR); Heeseok Han, Suwon-si (KR)

(21) Appl. No.: 18/987,532

(22) Filed: Dec. 19, 2024

(30) Foreign Application Priority Data
Jan. 22, 2024 (KR) 10-2024-0009790

(51) Int. Cl. H02M 1/00; H02M 1/14; H02M 3/04

(52) U.S. Cl. CPC H02M 1/0009; H02M 1/0025; H02M 1/14; H02M 3/04

(57) ABSTRACT

A power circuit includes a voltage conversion circuit including an inductor and configured to convert an input voltage applied to an input node and output an output voltage to an output node, a sensing circuit configured to output a first comparison voltage corresponding to a direct current (DC) component of an inductor current supplied to the inductor, a calibration circuit including a first resistor circuit and a second resistor circuit and configured to adjust the first comparison voltage and output a sensing voltage, a comparison circuit configured to generate a comparison signal, based on the sensing voltage, a reference voltage, and the output voltage, and a controller configured to output a control signal for adjusting a resistance of the first resistor circuit and a voltage adjustment ratio of the second resistor circuit to the first resistor circuit and the second resistor circuit, based on the comparison signal.

### CROSS-REFERENCE TO RELATED APPLICATION

This application is based on and claims priority under 35 U.S.C. § 119 to Korean Patent Application No. 10-2024-0009790, filed on Jan. 22, 2024, in the Korean Intellectual Property Office, the disclosure of which is incorporated by reference herein in its entirety.

### BACKGROUND

The inventive concept relates to a power circuit.

Electronic devices supply voltages required by internal devices (e.g., a processor, a memory, or the like) to operate. To this end, the electronic devices may include a circuit configured to convert the magnitude of a voltage and a circuit configured to sense current flowing inside the electronic device, and various methods of supplying required voltages to the internal devices of the electronic devices by using the circuits are being developed.

### SUMMARY

The inventive concept provides a power circuit including a current sensing circuit configured to sense current supplied to an inductor included in a voltage conversion circuit and generate a desired sensing voltage based on the sensed current.

According to an aspect of the inventive concept, there is provided a power circuit including a voltage conversion circuit including an inductor, the voltage conversion circuit being configured to convert an input voltage applied to an input node and output an output voltage to an output node, a sensing circuit configured to output a first comparison voltage corresponding to a direct current (DC) component of an inductor current supplied to the inductor, a calibration circuit including a first resistor circuit and a second resistor circuit, the calibration circuit being configured to adjust the first comparison voltage and output a sensing voltage, a comparison circuit configured to generate a comparison signal, based on the sensing voltage, a reference voltage, and the output voltage, and a controller configured to output, based on the comparison signal, a first control signal for adjusting a voltage adjustment ratio of the second resistor circuit to the second resistor circuit, and a second control signal for adjusting a resistance of the first resistor circuit to the first resistor circuit.

According to an aspect of the inventive concept, there is provided an operating method of a power circuit. The method includes applying an input voltage to an input node, converting the input voltage by using a voltage conversion circuit including an inductor and outputting an output voltage to an output node, outputting, by using a sensing circuit, a first comparison voltage corresponding to a DC component of an inductor current supplied to the inductor, outputting a sensing voltage by adjusting the first comparison voltage by using a calibration circuit including a first resistor circuit and a second resistor circuit, generating a comparison signal, based on the sensing voltage, a reference voltage, and the output voltage, by using a comparison circuit, and outputting, by using a controller, a first control signal for adjusting a voltage adjustment ratio of the second resistor circuit to the second resistor circuit and a second control signal for adjusting a resistance of the first resistor circuit to the first resistor circuit, based on the comparison signal.

According to an aspect of the inventive concept, there is provided a power circuit including a voltage conversion circuit including an inductor, a first resistor, a first capacitor, and a second resistor, the voltage conversion circuit being configured to convert an input voltage applied to an input node and output an output voltage to an output node, a sensing circuit including a third resistor, a second capacitor, a fourth resistor, and a third capacitor, the sensing circuit being configured to output a first comparison voltage corresponding to a DC component of an inductor current supplied to the inductor, a calibration circuit including a fifth resistor, a first amplifier, a first resistor circuit, and a second resistor circuit, the calibrating circuit being configured to adjust the first comparison voltage and output a sensing voltage, a comparison circuit including a comparator, the comparison circuit being configured to generate a comparison signal, based on the sensing voltage, a reference voltage, and the output voltage, and a controller configured to output a first control signal for adjusting a voltage adjustment ratio of the second resistor circuit to the second resistor circuit and a second control signal for adjusting a resistance of the first resistor circuit to the first resistor circuit, based on the comparison signal.

### BRIEF DESCRIPTION OF THE DRAWINGS

Embodiments will be more clearly understood from the following detailed description taken in conjunction with the accompanying drawings in which:

FIG. 1 is a block diagram of a power circuit according to an embodiment;

FIG. 2 is a circuit diagram of a voltage conversion circuit and a sensing circuit of a power circuit according to an embodiment;

FIG. 3 is a circuit diagram of a calibration circuit of a current sensing circuit according to an embodiment;

FIG. 4 is a circuit diagram of a first resistor circuit included in a calibration circuit according to an embodiment;

FIG. 5 is a circuit diagram of a second resistor circuit included in a calibration circuit according to an embodiment;

FIG. 6 is a circuit diagram of a comparison circuit and a controller of a current sensing circuit, according to an embodiment;

FIG. 7 is a flowchart of an operating method of a current sensing circuit, according to an embodiment;

FIG. 8 is a flowchart of a method of generating a comparison signal by a current sensing circuit according to an embodiment;

FIG. 9 is a flowchart of a method of solving a problem of a first comparison signal having different values according to a direct-current resistor (DCR) of an inductor during an initial operation of a power circuit according to an embodiment; and

FIG. 10 is a block diagram of an electronic device according to an embodiment.

### DETAILED DESCRIPTION OF THE EMBODIMENTS

Hereinafter, embodiments will be described in detail with reference to the accompanying drawings.

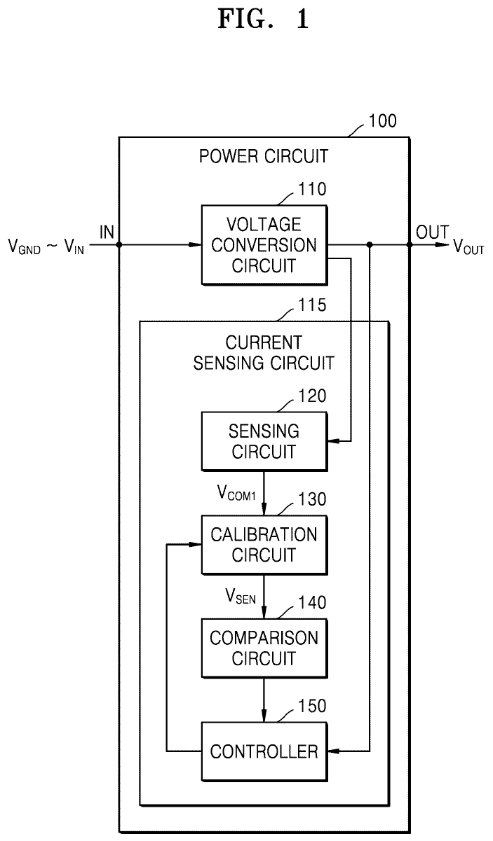

FIG. 1 is a block diagram of a power circuit according to an embodiment.

Referring to FIG. 1, a power circuit 100 according to an embodiment may include a voltage conversion circuit 110 and a current sensing circuit 115. The current sensing circuit 115 may include a sensing circuit 120, a calibration circuit 130, a comparison circuit 140, and a controller 150.

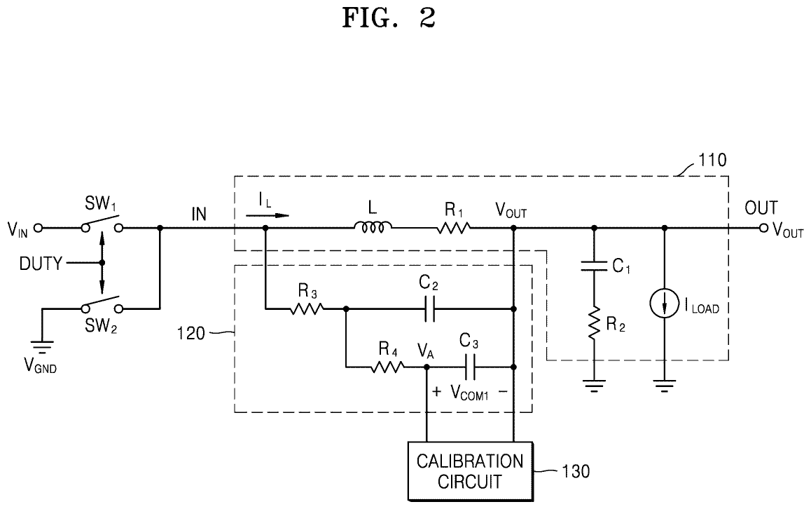

The voltage conversion circuit 110 may convert an input voltage into an output voltage V_{OUT} by using a low pass filter (LPF) including an inductor (refer to L in FIG. 2) and a capacitor (refer to C₁ in FIG. 2). In some embodiments, the input voltage may have alternately one of two voltage levels V_{GND} and V_{IN}. V_{GND} represents a ground voltage, and V_{IN} represents a higher voltage level than the ground voltage. The voltage conversion circuit 110 may include an inductor, a first resistor, a first capacitor, and a second resistor, and the first resistor may be a direct current resistor (DCR) of a coil that constitutes the inductor.

The voltage conversion circuit 110 may receive the input voltage through an input node IN and output the generated output voltage V_{OUT} through an output node OUT. For example, the voltage conversion circuit 110 may be a buck converter configured to generate the output voltage V_{OUT} by dropping the input voltage by using the inductor, the first resistor, the first capacitor, and the second resistor. A detailed structure of the voltage conversion circuit 110 is described below with reference to FIG. 2.

The sensing circuit 120 may output a first comparison voltage V_{COM1} corresponding to a direct current (DC) component of an inductor current supplied to the inductor included in the voltage conversion circuit 110. The sensing circuit 120 may include a third resistor, a second capacitor, a fourth resistor, and a third capacitor.

The sensing circuit 120 may output the first comparison voltage V_{COM1} corresponding to the DC component of the inductor current to the calibration circuit 130 by using the third capacitor. A detailed structure of the sensing circuit 120 is described below with reference to FIG. 2.

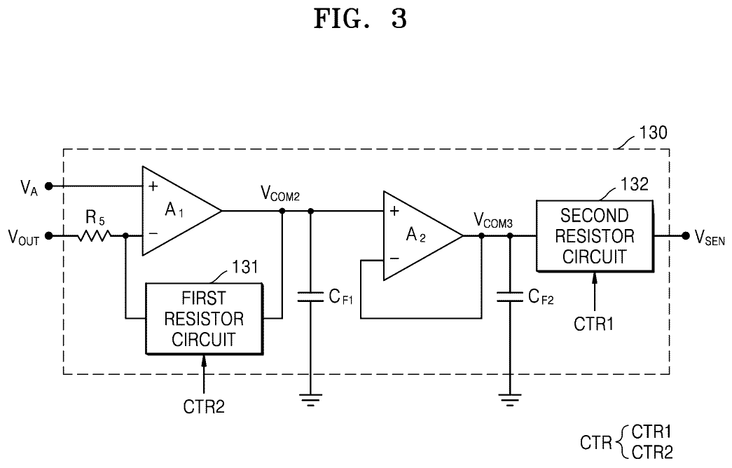

The calibration circuit 130 may output a sensing voltage V_{SEN} by adjusting a resistance of a first resistor circuit and a resistance of a second resistor circuit. The calibration circuit 130 may include a fifth resistor, a first amplifier (refer to A₁ in FIG. 3), the first resistor circuit, and the second resistor circuit. The calibration circuit 130 may further include a second amplifier (refer to A₂ in FIG. 3), a first filter capacitor, and a second filter capacitor.

The calibration circuit 130 may generate a second comparison voltage by adjusting a first comparison voltage by using the fifth resistor, the first amplifier, and the first resistor circuit. In this case, the resistance of the first resistor circuit included in the calibration circuit 130 may be adjusted based on a control signal (i.e., a second control signal CTR2 of FIG. 3) received from the controller 150.

The calibration circuit 130 may generate a sensing voltage by adjusting a second comparison voltage by using the second resistor circuit. In this case, a voltage adjustment ratio of the second resistor circuit included in the calibration circuit 130 may be adjusted based on a control signal (i.e., a first control signal CTR1 of FIG. 3) received from the controller 150.

A detailed structure of the calibration circuit 130 is described below with reference to FIGS. 3 to 5.

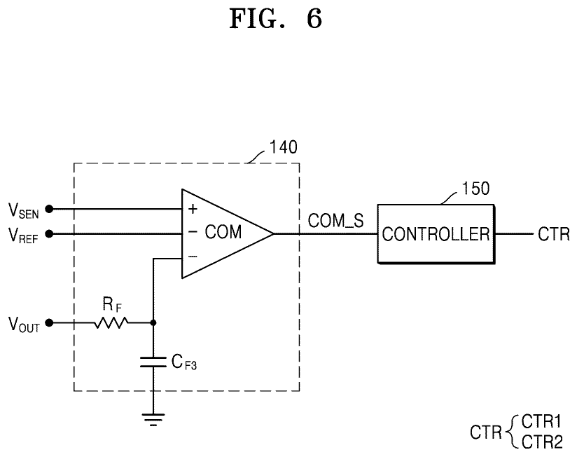

The comparison circuit 140 may generate a comparison signal based on the sensing voltage V_{SEN}, a reference voltage (refer to V_{REF} in FIG. 6), and the output voltage V_{OUT}. The comparison circuit 140 may include a comparator. The comparison circuit 140 may further include a filter resistor and a third filter capacitor. The comparison circuit 140 may generate a comparison signal having different values, based on a result of comparison of a value obtained by subtracting the reference voltage V_{REF} and the output voltage V_{OUT} from the sensing voltage V_{SEN} with 0 by using the comparator. The comparison circuit 140 may output the generated comparison signal to the controller 150. A detailed structure of the comparison circuit 140 is described below with reference to FIG. 6.

The controller 150 may output a control signal for adjusting the resistance of the first resistor circuit and the voltage adjustment ratio of the second resistor circuit to the first resistor circuit and the second resistor circuit, based on the comparison signal. Based on a magnitude of the comparison signal, the controller 150 may increase the sensing voltage V_{SEN} by outputting a control signal (i.e., the second control signal CRT2 in FIG. 3) for increasing the resistance of the first resistor circuit to the first resistor circuit or reduce the sensing voltage V_{SEN} by outputting a control signal (i.e., the first control signal CRT1 in FIG. 3) for reducing the voltage adjustment ratio of the second resistor circuit to the second resistor circuit. A detailed operation of the controller 150 is described below with reference to FIG. 6.

FIG. 2 is a circuit diagram of a voltage conversion circuit and a sensing circuit of a power circuit according to an embodiment.

Referring to FIG. 2, the voltage conversion circuit 110 according to an embodiment may include an inductor L, a first resistor R₁, a first capacitor C₁, and a second resistor R₂. The voltage conversion circuit 110 according to the present embodiment may further include a current source I_{LOAD}.

The voltage conversion circuit 110 may receive the input voltage applied through the input node IN. The input voltage having alternately one of the two voltage levels V_{GND} and V_{IN} may be applied to the inductor L.

The input voltage may have alternately one of two voltage levels V_{GND} and V_{IN} at a duty ratio. The input voltage may be generated by turning on or off a first switch SW₁ connected between a node having a voltage level V_{IN} and the input node IN and a second switch SW₂ connected between a voltage level V_{GND} and the input node IN in response to a duty signal DUTY. In this case, the first switch SW₁ and the second switch SW₂ may operate complementarily to each other. For example, during a first time when the first switch SW1 turns on, the second switch SW2 remains turned off, and during a second time when the second switch SW2 turns on, the first switch SW1 remains turned off. In some embodiments, the duty ratio may correspond to a ratio of the first time to a sum of the first and second times. Accordingly, a voltage having a voltage level V_{IN} and a voltage having a voltage level V_{GND} may be applied to the input node IN at different points in time.

One end of the inductor L may be connected to the input node IN. When the input voltage is applied to the one end of the inductor L, an inductor current I_{L} may be supplied to the inductor L. The other end of the inductor L may be connected to the first resistor R₁.

One end of the first resistor R₁ may be connected to the other end of the inductor L. The other end of the first resistor R₁ may be connected to the output node OUT. That is, the first resistor R₁ may be connected between the inductor L and the output node OUT. The first resistor R₁ may be a modeled element of a direct current resistance (DCR) of the inductor L. The DCR of the inductor L is the resistance that the inductor L exhibits to a flow of direct current (DC) due to the resistive properties of a wire used to wind the inductor L.

One end of the first capacitor C₁ may be connected to the output node OUT. That is, the one end of the first capacitor C₁ may be connected to the other end of the first resistor R₁. The other end of the first capacitor C₁ may be connected to a ground node.

One end of the second resistor R₂ may be connected to the other end of the first capacitor C₁. The other end of the second resistor R₂ may be connected to the ground node. That is, the second resistor R₂ may be connected between the first capacitor C₁ and the ground node. The second resistor R₂ may be a modeled element of a resistor inside the first capacitor C₁.

The inductor L, the first resistor R₁, the first capacitor C₁, and the second resistor R₂ may convert the input voltage applied to the input node IN into an output voltage V_{OUT} and output the output voltage V_{OUT} to the output node OUT. In an embodiment, the inductor L, the first resistor R₁, the first capacitor C₁, and the second resistor R₂ may serve as a buck converter, and thus, the output voltage V_{OUT} having a lower magnitude than the input voltage may be output to the output node OUT.

One end of the current source I_{LOAD} may be connected to the output node OUT. That is, the one end of the current source I_{LOAD} may be connected to the other end of the first resistor R₁ and the one end of the first capacitor C₁. The other end of the current source I_{LOAD} may be connected to the ground node. As in the embodiment shown in FIG. 2, when the voltage conversion circuit 110 operates as a buck converter, the current source I_{LOAD} may correspond to a DC component of the inductor current I_{L}.

The sensing circuit 120 according to an embodiment may include a third resistor R₃, a second capacitor C₂, a fourth resistor R₄, and a third capacitor C₃.

One end of the third resistor R₃ may be connected to the input node IN and the other end of the inductor L. The other end of the third resistor R₃ may be connected to one end of the second capacitor C₂.

The one end of the second capacitor C₂ may be connected to the other end of the third resistor R₃. The other end of the second capacitor C₂ may be connected to the output node OUT. That is, the third resistor R₃ and the second capacitor C₂ may be connected in parallel to the inductor L and the first resistor R₁.

In this case, a second capacitor voltage, which is a voltage applied to opposite ends of the second capacitor C₂ may be expressed as in Equation 1:

$${V}_{C 2} = \frac{{I}_{L} {R}_{1} ( 1 + s \frac{L}{{R}_{1}} )}{( 1 + {sR}_{3} {C}_{2} )} \qquad [ Equation 1 ]$$

In Equation 1, V_{C2} denotes the second capacitor voltage, I_{L} denotes the inductor current supplied to the inductor L, R₁ denotes a resistance of the first resistor R₁, s denotes a Laplace variable, L denotes an inductance of the inductor L, R₃ denotes a resistance of the third resistor R₃, and C₂ denotes a capacitance of the second capacitor C₂.

One end of the fourth resistor R₄ may be connected to the other end of the third resistor R₃. That is, the one end of the fourth resistor R₄ may be connected to a node between the third resistor R₃ and the second capacitor C₂. The other end of the fourth resistor R₄ may be connected to one end of the third capacitor C₃.

The one end of the third capacitor C₃ may be connected to the other end of the fourth resistor R₄. The other end of the third capacitor C₃ may be connected to the output node OUT. That is, the fourth resistor R₄ and the third capacitor C₃ may be connected in parallel to the second capacitor C₂.

In this case, a third capacitor voltage, which is a voltage applied to opposite ends of the third capacitor C₃, may be expressed as in Equation 2 because a voltage corresponding to a DC component of the inductor current is filtered by the third capacitor C₃.

$${V}_{C 3} = {I}_{LOAD} {R}_{1} \qquad [ Equation 2 ]$$

In Equation 2, V_{C3} denotes the third capacitor voltage, I_{LOAD} denotes the DC component of the inductor current, and R₁ denotes a resistance of the first resistor R₁.

The sensing circuit 120 may obtain the third capacitor voltage V_{C3} corresponding to the DC component of the inductor current by using the third resistor R₃, the second capacitor C₂, the fourth resistor R₄, and the third capacitor C₃. The sensing circuit 120 may output the third capacitor voltage as the first comparison voltage V_{COM1} to the calibration circuit 130. The first comparison voltage V_{COM1} may be the difference between a voltage V_{A} of a node between the fourth resistor R₄ and the third capacitor C₃ and the output voltage V_{OUT}. In other words, the voltage V_{A} of the node corresponds to a sum of the output voltage V_{OUT} and the first comparison voltage V_{COM1} (i.e., V_{OUT}+V_{COM1}).

FIG. 3 is a circuit diagram of a calibration circuit of a current sensing circuit according to an embodiment.

Referring to FIG. 3, a calibration circuit 130 according to an embodiment may include a fifth resistor R₅, a first amplifier A₁, a first resistor circuit 131, and a second resistor circuit 132. The calibration circuit 130 may further include a second amplifier A₂, a first filter capacitor C_{F1}, and a second filter capacitor C_{F2}. In some embodiments, the first amplifier A₁ and the second amplifier A₂ may be differential amplifiers such as operational amplifiers.

One end of the fifth resistor R₅ may be connected to the output node OUT. The other end of the fifth resistor R₅ may be connected to a first input terminal of the first amplifier A₁.

The first input terminal of the first amplifier A₁ may be connected to the other end of the fifth resistor R₅. A second input terminal of the first amplifier A₁ may be connected to a node between a fourth resistor R₄ and a third capacitor C₃. That is, the second input terminal of the first amplifier A₁ may be connected to a node having a voltage V_{A} with a second input voltage level. In the embodiment shown in FIG. 3, the first input terminal of the first amplifier A₁ may be a negative (−) input terminal, and the second input terminal of the first amplifier A₁ may be a positive (+) input terminal.

The first amplifier A₁ may output a second comparison voltage V_{COM2} through an output terminal thereof. The second comparison voltage V_{COM2} may be expressed as in Equation 3:

$${V}_{COM 2} = {V}_{OUT} + {V}_{C 3} \frac{{R}_{5} + {R}_{C 1}}{{R}_{5}} \qquad [ Equation 3 ]$$

In Equation 3, V_{COM2} denotes the second comparison voltage, V_{OUT} denotes an output voltage, V_{C3} denotes a third capacitor voltage, R₅ denotes a resistance of the fifth resistor R₅, and R_{C1} denotes a resistance of the first resistor circuit 131.

One end of the first resistor circuit 131 may be connected to the first input terminal of the first amplifier A₁. The other end of the first resistor circuit 131 may be connected to the output terminal of the first amplifier A₁. A resistance of the first resistor circuit 131 may be adjusted in response to the second control signal CTR2 received by the controller 150.

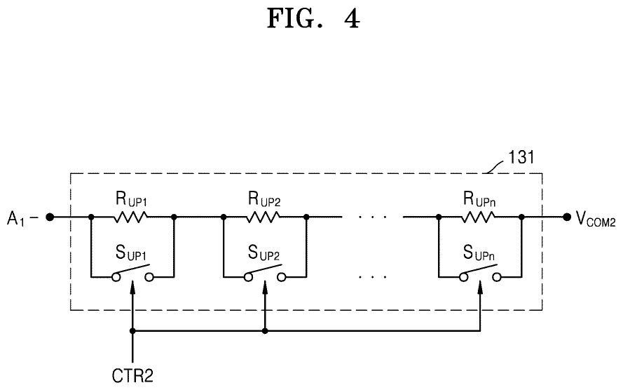

A detailed structure of the first resistor circuit 131 and the resistance of the first resistor circuit 131 may be described in further detail with reference to FIG. 4.

FIG. 4 is a circuit diagram of a first resistor circuit included in a calibration circuit according to an embodiment.

Referring to FIG. 4, the first resistor circuit 131 according to an embodiment may include a plurality of pull-up resistors R_{UP1} to R_{UPn} and a plurality of pull-up switches S_{UP1} to S_{UP1}.

The plurality of pull-up resistors R_{UP1} to R_{UPn} may be connected in series between a first input terminal of a first amplifier A₁ and an output terminal of the first amplifier A₁. That is, one end of a first pull-up resistor R_{UP1} may be connected to the first input terminal of the first amplifier A₁, one end of a second pull-up resistor R_{UP2} may be connected to the other end of the first pull-up resistor R_{UP1}, one end of a third pull-up resistor R_{UP3} may be connected to the other end of the second pull-up resistor R_{UP2}. By repeating the connection, one end of an n-th pull-up resistor R_{UPn} may be connected to the other end of an n−1-th pull-up resistor R_{UPn-1}, and the other end of the n-th pull-up resistor R_{UPn} may be connected to the output terminal of the first amplifier A₁.

The plurality of pull-up switches S_{UP1} to S_{UPn} may be respectively connected in parallel to the plurality of pull-up resistors R_{UP1} to R_{UPn}. That is, a first pull-up switch S_{UP1} may be connected in parallel to the first pull-up resistor R_{UP1}, and a second pull-up switch S_{UP2} may be connected in parallel to the second pull-up resistor R_{UP2}. By repeating the connection, an n-th pull-up switch S_{UPn} may be connected in parallel to the n-th pull-up resistor R_{UPn}.

The plurality of pull-up switches S_{UP1} to S_{UPn} may be turned on or off in response to the second control signal CTR2. As can be seen from Equation 3, the second comparison voltage V_{COM2} may be proportional to a resistance R_{C1} of the first resistor circuit 131. Accordingly, the controller 150 may increase the second comparison voltage V_{COM2} by increasing the resistance R_{C1} of the first resistor circuit 131 in response to the second control signal CTR2.

When each of the plurality of pull-up switches S_{UP1} to S_{UPn} is turned on in response to the second control signal CTR2, current may be prevented from flowing into each of the plurality of pull-up resistors R_{UP1} to R_{UPn}, which are connected in parallel to the plurality of pull-up switches S_{UP1} to S_{UPn}. In other words, when each of the plurality of pull-up switches S_{UP1} to S_{UPn} is turned on in response to the second control signal CTR2, the resistance R_{C1} of the first resistor circuit 131 may be reduced.

Conversely, when each of the plurality of pull-up switches S_{UP1} to S_{UPn} is turned off in response to the second control signal CTR2, current may be allowed to flow into each of the plurality of pull-up resistors R_{UP1} to R_{UPn} connected in parallel to the plurality of pull-up switches S_{UP1} to S_{UPn}. In other words, when each of the plurality of pull-up switches S_{UP1} to S_{UPn} is turned off in response to the second control signal CTR2, the resistance R_{C1} of the first resistor circuit 131 may increase.

In some embodiments, each of the plurality of pull-up switches S_{UP1} to S_{UPn} may be controlled independently. The second control signal CTR2 may have a plurality of sub-control signals controlling the plurality of pull-up switches S_{UP1} to S_{UPn}, respectively. For example, when all of the plurality of pull-up resistors R_{UP1} to R_{UPn} have the same resistance, the controller 150 may increase the resistance R_{C1} of the first resistor circuit 131 by increasing the number of pull-up switches that are turned off, from among the plurality of pull-up switches S_{UP1} to S_{UPn}, in response to the second control signal CTR2. In addition, the controller 150 may reduce the resistance R_{C1} of the first resistor circuit 131 by increasing the number of pull-up switches that are turned on, from among the plurality of pull-up switches S_{UP1} to S_{UPn}, in response to the second control signal CTR2.

For example, when the plurality of pull-up resistors R_{UP1} to R_{UPn} have respectively different resistances, the controller 150 may adjust the resistance R_{C1} of the first resistor circuit 131 by changing a combination of switches that are turned off, from among the plurality of pull-up switches S_{UP1} to S_{UPn}, in response to the second control signal CTR2.

Referring back to FIG. 3, one end of a first filter capacitor C_{F1} may be connected to the output terminal of the first amplifier A1. The other end of the first filter capacitor C_{F1} may be connected to the ground node. The first filter capacitor C_{F1} may filter noise included in the second comparison voltage V_{COM2}.

A first input terminal of the second amplifier A₂ may be connected to the output terminal of the first amplifier A₁. A second input terminal of the second amplifier A₂ may be connected to an output terminal of the second amplifier A₂. In the embodiment shown in FIG. 3, the first input terminal of the second amplifier A₂ may be a positive (+) input terminal, and the second input terminal of the second amplifier A₂ may be a negative (−) input terminal. The second amplifier A₂ may output a third comparison voltage V_{COM3}, which is generated by amplifying the second comparison voltage V_{COM2} by a multiple of 1. In other words, the second amplifier A₂ may serve as a buffer and output the third comparison voltage V_{COM3}, which is the same as the second comparison voltage V_{COM2}. In some embodiments, the second amplifier A₂ and the second filter capacitor C_{F2} may be omitted, and the output terminal of the first amplifier A₁ may be connected to the second resister circuit 132. In this case, the second comparison voltage V_{COM2} filtered by the first filter capacitor C_{F1} may be inputted into the second resistor circuit 132 as the third comparison voltage V_{COM3}.

One end of a second filter capacitor C_{F2} may be connected to the output terminal of the second amplifier A₂. The other end of the second filter capacitor C_{F2} may be connected to the ground node. The second filter capacitor C_{F2} may filter noise included in the third comparison voltage V_{COM3} that has passed through the second amplifier A₂.

One end of the second resistor circuit 132 may be connected to the output terminal of the first amplifier A₁ through the second amplifier A₂, the first filter capacitor C_{F1}, and the second filter capacitor C_{F2}. The other end of the second resistor circuit 132 may be connected to an output terminal of a calibration circuit 130. Accordingly, a sensing voltage V_{SEN} may be output through the other end of the second resistor circuit 132. A voltage adjustment ratio of the second resistor circuit 132 may be adjusted in response to the first control signal CTR1 received by the controller 150.

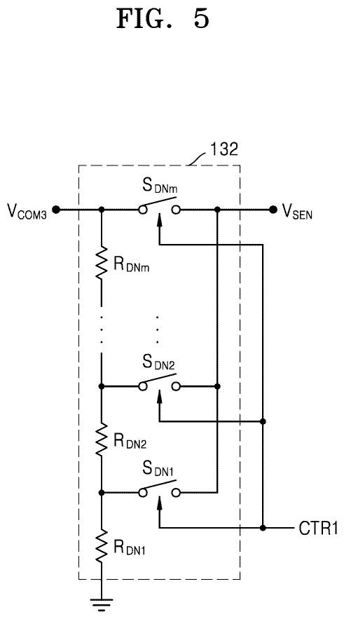

A detailed structure of the second resistor circuit 132 and the voltage adjustment ratio of the second resistor circuit 132 may be described in detail with reference to FIG. 5.

FIG. 5 is a circuit diagram of a second resistor circuit included in a calibration circuit according to an embodiment.

Referring to FIG. 5, the second resistor circuit 132 according to an embodiment may include a plurality of pull-down resistors R_{DN1} to R_{DNm} and a plurality of pull-down switches S_{DN1} to S_{DNm}.

The plurality of pull-down resistors R_{DN1} to R_{DNm} may be connected in series between an output terminal of a second amplifier A₂ and the ground node. That is, one end of a first pull-down resistor R_{DN1} may be connected to the ground node, one end of a second pull-down resistor R_{DN2} may be connected to the other end of the first pull-down resistor R_{DN1}, and one end of a third pull-down resistor R_{DN3} may be connected to the other end of the second pull-down resistor R_{DN2}. By repeating the connection, one end of an m-th pull-down resistor R_{DNm} may be connected to the other end of an (m−1)-th pull-down resistor R_{DNm-1}, and the other end of the m-th pull-down resistor R_{DNm} may be connected to the output terminal of the second amplifier A₂.

Each of the plurality of pull-down switches S_{DN1} to S_{DNm} may be connected between one end of a corresponding one of the plurality of pull-down resistors R_{DN1} to R_{DNm} and an output terminal of a calibration circuit 130. That is, a first pull-down switch S_{DN1} may be connected between the one end of the first pull-down resistor R_{DN1} and the output terminal of the calibration circuit 130, and a second pull-down switch S_{DN2} may be connected between the one end of the second pull-down resistor R_{DN2} and the output terminal of the calibration circuit 130. By repeating the connection, an m-th pull-down switch S_{DNm} may be connected between the one end of an m-th pull-down resistor R_{DNm} and the output terminal of the calibration circuit 130.

A relationship between the third comparison voltage V_{COM3} and a sensing voltage V_{SEN} may be expressed as in Equation 4:

$${V}_{SEN} = \frac{{\sum }_{i = 1}^{k} {R}_{DNi}}{{R}_{DN 1} + … + {R}_{DNm}} {V}_{COM 3} \qquad [ Equation 4 ]$$

In Equation 4, V_{SEN} denotes the sensing voltage, V_{COM3} denotes the third comparison voltage, R_{DN1} to R_{DNm} denote resistances of the first to m-th pull-down resistors R_{DN1} to R_{DNm}, and k denotes an index of a pull-down switch that is turned on in response to the first control signal CTR1, from among the plurality of pull-down switches S_{DN1} to S_{DNm}.

The plurality of pull-down switches S_{DN1} to S_{DNm} may be independently turned on or off in response to the first control signal CTR1. The controller 150 may adjust a voltage adjustment ratio of the second resistor circuit 132 by selecting a pull-down switch that is turned on, from among the plurality of pull-down switches S_{DN1} to S_{DNm}, in response to the first control signal CTR1. As can be seen from Equation 4, when the index of the pull-down switch that is turned on in response to the first control signal CTR1, from among the plurality of pull-down switches S_{DN1} to S_{DNm}, is reduced, the voltage adjustment ratio of the second resistor circuit 132 may reduce, and thus, a voltage may be reduced to a greater extent by the second resistor circuit 132. Conversely, when the index of the pull-down switch that is turned on due to the first control signal CTR1, from among the plurality of pull-down switches S_{DN1} to S_{DNm}, increases, the voltage adjustment ratio of the second resistor circuit 132 may be increased, and thus, a voltage may be reduced to a smaller extent by the second resistor circuit 132. The second resistor circuit 132 may serve as a voltage divider of the third comparison voltage V_{COM3}.

As described above, the controller 150 may adjust the sensing voltage V_{SEN} by adjusting the index of the pull-down switch that is turned on, from among the plurality of pull-down switches S_{DN1} to S_{DNm}, in response to the first control signal CTR1. For example, the index indicates which pull-down switch is turned on among the plurality of pull-down switches S_{DN1} to S_{DNm}. For example, the index is m, k is m and m-th pull-down switch S_{DNm} turns on and the other pull-down switches S_{DN1} to S_{DN(m-1)} stay turned off. In this case, the third comparison voltage V_{COM3} is outputted as the sensing voltage V_{SEN} without voltage adjustment. When the index is 1, k is 1 and the first pull-down switch S_{DN1} turns on and the other pull-down switches S_{DN2} to S_{DNm} stay turned off. In this case, the third comparison voltage V_{COM3} is adjusted by (R_{DN1}/(R_{DN1}+ . . . +R_{DNm})) and such adjusted voltage is outputted as the sensing voltage V_{SEN}.

Referring back to FIG. 3, the calibration circuit 130 may output the sensing voltage V_{SEN} generated by the second resistor circuit 132 to the comparison circuit 140.

FIG. 6 is a circuit diagram of a comparison circuit and a controller of a current sensing circuit according to an embodiment.

Referring to FIG. 6, the comparison circuit 140 according to an embodiment may include a comparator COM. The comparison circuit 140 may further include a filter resistor R_{F} and a third filter capacitor C_{F3}.

The comparator COM may receive the sensing voltage V_{SEN} through a first input terminal thereof from the second resistor circuit 132. The comparator COM may receive a reference voltage V_{REF} through a second input terminal thereof. The comparator COM may receive the output voltage V_{OUT} through a third input terminal thereof. In the embodiment shown in FIG. 6, the first input terminal of the comparator COM may be a positive (+) input terminal, the second input terminal of the comparator COM may be a first negative (−) input terminal, and the third input terminal of the comparator COM may be a second negative (−) input terminal.

In this case, the filter resistor R_{F} and the third filter capacitor C_{F3} may be connected to the third input terminal of the comparator COM.

One end of the filter resistor R_{F} may be connected to the third input terminal of the comparator COM. The other end of the filter resistor R_{F} may be connected to the output node OUT.

One end of the third filter capacitor C_{F3} may be connected to the third input terminal of the comparator COM. The other end of the third filter capacitor C_{F3} may be connected to the ground node.

The filter resistor R_{F} and the third filter capacitor C_{F3} may filter noise included in the output voltage V_{OUT}.

The comparator COM may output a comparison signal COM_S through an output terminal thereof. The comparator COM may generate the comparison signal COM_S based on the sensing voltage V_{SEN}, the reference voltage V_{REF}, and the output voltage V_{OUT}. In this case, the reference voltage V_{REF} may be set to a target value of the first comparison voltage V_{COM1}.

In an embodiment, the comparator COM may generate a comparison signal COM_S having a first value (e.g., 1 or more) when the value obtained by subtracting the reference voltage V_{REF} and the output voltage V_{OUT} from the sensing voltage V_{SEN} is more than 0. Conversely, the comparator COM may generate a comparison signal COM_S having a second value (e.g., less than 1) when the value obtained by subtracting the reference voltage V_{REF} and the output voltage V_{OUT} from the sensing voltage V_{SEN} is less than 0. In some embodiments, the first value may be less than 1 and the second value may be 1 or more.

The controller 150 may receive the comparison signal COM_S. The controller 150 may generate a control signal CTR based on the comparison signal COM_S. The control signal CTR may include the first control signal CTR1 and the second control signal CTR2.

In an embodiment, when the comparison signal COM_S is the first value, the controller 150 may output, to the second resistor circuit 132, the first control signal CTR1 for reducing a voltage adjustment ratio of the second resistor circuit 132. That is, when the comparison signal COM_S is the first value, the controller 150 may reduce the sensing voltage V_{SEN} by reducing the voltage adjustment ratio of the second resistor circuit 132.

The controller 150 may output the first control signal CTR1 for turning on one of a plurality of pull-down switches S_{DN1} to S_{DNm} to the second resistor circuit 132, based on a reduction ratio of the third comparison voltage V_{COM3} by the second resistor circuit 132. The reduction ratio of the third comparison voltage V_{COM3} may be a ratio at which the third comparison voltage V_{COM3} is reduced to reduce the sensing voltage V_{SEN} by a desired amount. In this case, the reduction ratio of the third comparison voltage V_{COM3} may be proportional to a reduction ratio of the sensing voltage V_{SEN}. Accordingly, when there is a need to increase the reduction ratio of the sensing voltage V_{SEN}, the controller 150 may reduce an index of a pull-down switch that is turned on in response to the first control signal CTR1, from among the plurality of pull-down switches S_{DN1} to S_{DNm}, to increase the reduction ratio of the third comparison voltage V_{COM3}.

In an embodiment, when the comparison signal COM_S is a second value, the controller 150 may output, to the first resistor circuit 131, the second control signal CTR2 for increasing a resistance of the first resistor circuit 131. That is, when the comparison signal COM_S is the second value, the controller 150 may increase the sensing voltage V_{SEN} by increasing the resistance of the first resistor circuit 131.

The controller 150 may output the second control signal CTR2 for turning on at least one of the plurality of pull-up switches S_{UP1} to S_{UPn} to the first resistor circuit 131, based on an increase ratio of the first comparison voltage V_{COM1} by the first resistor circuit 131. The increase ratio of the third first voltage V_{COM1} may be a ratio at which the first comparison voltage V_{COM1} is increased to increase the sensing voltage V_{SEN} by a desired amount. In this case, the increase ratio of the first comparison voltage V_{COM1} may be proportional to an increase ratio of the sensing voltage V_{SEN}. Accordingly, when there is a need to increase the increase ratio of the sensing voltage V_{SEN}, the controller 150 may increase the number of switches that are turned off, from among the plurality of pull-up switches S_{UP1} to S_{UPn}, to increase the increase ratio of the first comparison voltage V_{COM1}.

When a power circuit 100 according to the embodiment described above is used, the resistance of the first resistor circuit 131 and the voltage adjustment ratio of the second resistor circuit 132 in a calibration circuit 130 may be calibrated, based on the comparison signal COM_S, and thus, the sensing voltage V_{SEN} having a desired magnitude may be generated.

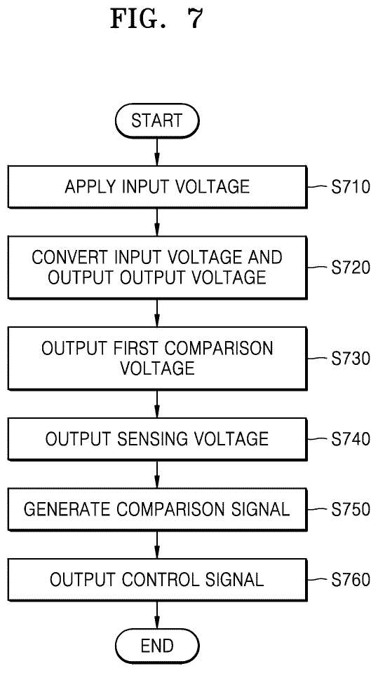

FIG. 7 is a flowchart of an operating method of a current sensing circuit, according to an embodiment.

Referring to FIG. 7, in operation S710, the power circuit 100 may receive the input voltage from the input node IN. The power circuit 100 may receive the input voltage applied to the input node IN, by using the voltage conversion circuit 110.

In operation S720, the power circuit 100 may output the output voltage V_{OUT} by converting the input voltage. The power circuit 100 may convert the input voltage by using the inductor L, the first resistor R₁, the first capacitor C₁, and the second resistor R₂ of the voltage conversion circuit 110 and generate the output voltage V_{OUT}.

In operation S730, the power circuit 100 may output the first comparison voltage V_{COM1}. The power circuit 100 may output the first comparison voltage V_{COM1} corresponding to a DC component of the inductor current I_{L} supplied to the inductor L included in the voltage conversion circuit 110, by using the third resistor R₃, the second capacitor C₂, the fourth resistor R₄, and the third capacitor C₃ of the sensing circuit 120.

In operation S740, the power circuit 100 may output the sensing voltage V_{SEN}. The power circuit 100 may generate the second comparison voltage V_{COM2}, based on the first comparison voltage V_{COM1}, by using the fifth resistor R₅, the first amplifier A₁, and the first resistor circuit 131 of the calibration circuit 130. The power circuit 100 may generate the third comparison voltage V_{COM3}, based on the second comparison voltage V_{COM2}, by using the second amplifier A₂ of the calibration circuit 130. The power circuit 100 may generate and output the sensing voltage V_{SEN}, based on the third comparison voltage V_{COM3}, by using the second resistor circuit 132 of the calibration circuit 130.

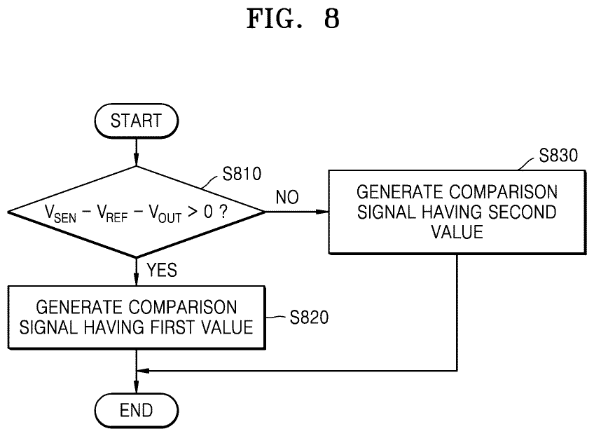

In operation S750, the power circuit 100 may generate the comparison signal COM_S. The power circuit 100 may generate the comparison signal COM_S, based on the sensing voltage V_{SEN}, the reference voltage V_{REF}, and the output voltage V_{OUT}, by using the comparator COM of the comparison circuit 140. A method of generating the comparison signal COM_S by using the comparison circuit 140 may be described with reference to FIG. 8.

FIG. 8 is a flowchart of a method of generating a comparison signal by a current sensing circuit according to an embodiment.

Referring to FIG. 8, in operation S810, the power circuit 100 may determine whether a value obtained by subtracting the reference voltage V_{REF} and the output voltage V_{OUT} from the sensing voltage V_{SEN} is more than 0 by using the comparator COM of the comparison circuit 140.

When it is determined that the value obtained by subtracting the reference voltage V_{REF} and the output voltage V_{OUT} from the sensing voltage V_{SEN} is more than 0, the method may proceed to operation S820, and thus, the power circuit 100 may generate the comparison signal COM_S having the first value by using the comparator COM of the comparison circuit 140.

When it is determined that the value obtained by subtracting the reference voltage V_{REF} and the output voltage V_{OUT} from the sensing voltage V_{SEN} is 0 or less, the method may proceed to operation S830, and thus, the power circuit 100 may generate a comparison signal COM_S having the second value by using the comparator COM of the comparison circuit 140.

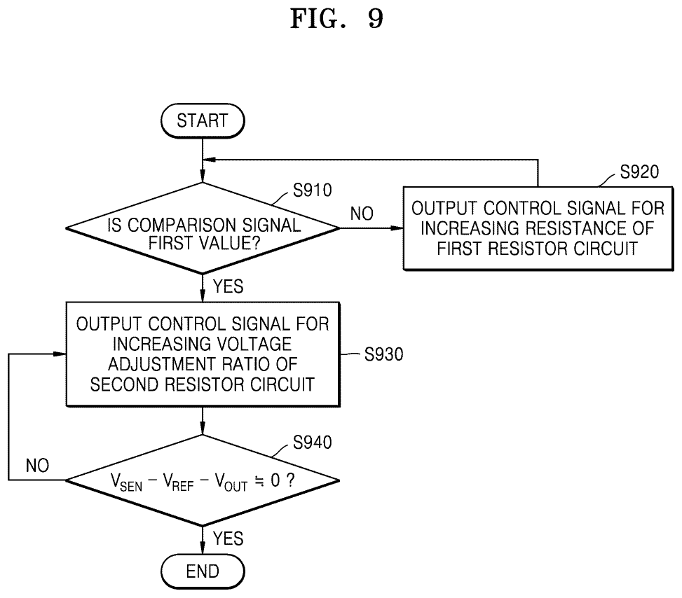

Referring to FIG. 7, in operation S760, the power circuit 100 may output the control signal CTR. The power circuit 100 may generate the control signal CTR, based on the comparison signal COM_S, by using the controller 150. A method of generating the control signal CTR by the controller 150 may be described with reference to FIG. 9.

FIG. 9 is a flowchart of a method of solving a problem of a first comparison signal having different values according to a DCR of an inductor during an initial operation of a power circuit according to an embodiment.

Referring to FIG. 9, a method of generating the control signal CTR in response to the comparison signal COM_S of the power circuit 100 may be performed. Operations shown in FIG. 9 may be operations of solving a problem of the first comparison voltage V_{COM1} having different values from a target voltage such as the reference voltage V_{REF} according to a resistance of the first resistor R₁ corresponding to a DCR of the inductor L included in the voltage conversion circuit 110 during an initial operation of the power circuit 100. By performing the operations shown in FIG. 9, the power circuit 100 may adjust a resistance of the first resistor circuit 131 and a voltage adjustment ratio of the second resistor circuit 132 and generate the sensing voltage V_{SEN} having a desired magnitude.

In operation S910, the power circuit 100 may determine whether the comparison signal COM_S is the first value, by using the controller 150.

When it is determined that the comparison signal COM_S is not the first value, the method may proceed to operation S920, and the power circuit 100 may generate the second control signal CTR2 for increasing the resistance of the first resistor circuit 131 by using the controller 150. After the resistance of the first resistor circuit 131 is increased, the method may proceed to operation S910, and the power circuit 100 may determine again by using the controller 150 whether a comparison signal newly output by the comparison circuit 140 is the first value. Otherwise, in operation S910, when it is determined that the comparison signal COM_S is the first value, the method may proceed to operation S930, and the power circuit 100 may generate the first control signal CTR1 for reducing a resistance adjustment ratio of the second resistor circuit 132 by using the controller 150.

After the resistance adjustment ratio of the second resistor circuit 132 is reduced, the method may proceed to operation S940, and the power circuit 100 may determine by using the controller 150 whether a value obtained by subtracting the reference voltage V_{REF} and the output voltage V_{OUT} from the sensing voltage V_{SEN} is close to 0. In this case, by determining whether the value obtained by subtracting the reference voltage V_{REF} and the output voltage V_{OUT} from the sensing voltage V_{SEN} is within a predetermined reference range (e.g., within a range of −0.01 to 0.01), the controller 150 may determine the value obtained by subtracting the reference voltage V_{REF} and the output voltage V_{OUT} from the sensing voltage V_{SEN} is close to 0. In this case, the reference range may be set according to conditions required by an electronic device using the power circuit 100. When it is determined that the value obtained by subtracting the reference voltage V_{REF} and the output voltage V_{OUT} from the sensing voltage V_{SEN} is not close to 0 (i.e., out of the range of −0.01 to 0.01), the method may proceed to operation S930, and the power circuit 100 may generate the first control signal CTR1 for reducing the resistance adjustment ratio of the second resistor circuit 132 by using the controller 150.

Otherwise, when it is determined that the value obtained by subtracting the reference voltage V_{REF} and the output voltage V_{OUT} from the sensing voltage V_{SEN} is close to 0, a process of generating the control signal CTR (e.g., the first control signal CTR1) may be terminated.

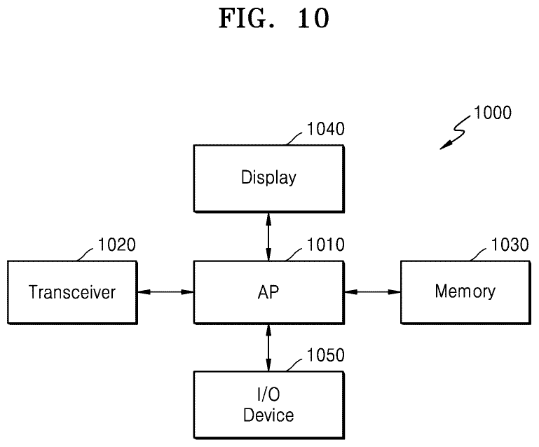

FIG. 10 is a block diagram of an electronic device 1000 according to an embodiment.

Referring to FIG. 10, the electronic device 1000 may include an application processor (AP) 1010, a transceiver 1020, a memory 1030, a display 1040, and an input/output (I/O) device 1050.

The AP 1010 may control all operations of the electronic device 1000 and operations of components of the electronic device 1000. The AP 1010 may perform various operations. According to some embodiments, the AP 1010 may include one processor core (or a single-core) or a plurality of processor cores (or a multi-core).

The electronic device 1000 may communicate with the outside through the transceiver 1020. The transceiver 1020 may be, for example, a wired local area network (LAN), a wireless short-range communication interface (e.g., Bluetooth, wireless fidelity (Wi-Fi), and Zigbee), power line communication (PLC), or a modem communication interface that may connect to a mobile cellular network (e.g., 3rd Generation (3G), long-term evolution (LTE), 5G, new radio (NR), and next-generation communication).

The memory 1030 may store command code, control data, or user data that may control the electronic device 1000. The memory 1030 may include at least one of a volatile memory and a non-volatile memory.

The display 1040 may display internal status information of the electronic device 1000. The display 1040 may include a touch sensor (not shown). In addition, the display 1040 may include an input or output function and outer appearance for a user interface. A user may control the electronic device 1000 by using the touch sensor and the user interface.

The I/O device 1050 may include an input unit, such as a touchpad, a keypad, and an input button, and an output unit, such as a display and a speaker.

At least some of the components of the electronic device 1000, which include, for example, the AP 1010, the transceiver 1020, the memory 1030, the display 1040, and the I/O device 1050, may include a power circuit configured to generate a voltage having a desired magnitude, and the power circuit may include the power circuit 100 according to the embodiments described above with reference to FIGS. 1 to 9.

While the inventive concept has been particularly shown and described with reference to embodiments thereof, it will be understood that various changes in form and details may be made therein without departing from the spirit and scope of the following claims.

1. A power circuit comprising:
a voltage conversion circuit comprising an inductor, the voltage conversion circuit being configured to convert an input voltage applied to an input node and output an output voltage to an output node;
a sensing circuit configured to output a first comparison voltage corresponding to a direct current (DC) component of an inductor current supplied to the inductor;
a calibration circuit comprising a first resistor circuit and a second resistor circuit, the calibration circuit being configured to adjust the first comparison voltage and output a sensing voltage;
a comparison circuit configured to generate a comparison signal, based on the sensing voltage, a reference voltage, and the output voltage; and
a controller configured to output, based on the comparison signal:
a first control signal for adjusting a voltage adjustment ratio of the second resistor circuit to the second resistor circuit, and
a second control signal for adjusting a resistance of the first resistor circuit to the first resistor circuit.

2. The power circuit of claim 1,
wherein the voltage conversion circuit comprises:
the inductor having one end connected to the input node;
a first resistor having one end connected to the other end of the inductor and the other end connected to the output node;
a first capacitor having one end connected to the output node;
a second resistor having one end connected to the other end of the first capacitor and having the other end connected to a ground node; and
a current source having one end connected to the output node and having the other end connected to the ground node.

3. The power circuit of claim 1,
wherein the sensing circuit comprises:
a third resistor having one end connected to one end of the inductor;
a second capacitor having one end connected to the other end of the third resistor and having the other end connected to the output node;
a fourth resistor having one end connected to the other end of the third resistor; and
a third capacitor having one end connected to the other end of the fourth resistor and having the other end connected to the output node.

4. The power circuit of claim 3,
wherein the sensing circuit outputs a voltage applied to opposite ends of the third capacitor as the first comparison voltage to the calibration circuit.

5. The power circuit of claim 1,
wherein the calibration circuit comprises:
a fifth resistor having one end connected to the output node;
a first amplifier having a first input terminal connected to the other end of the fifth resistor and having a second input terminal connected to a node of which a voltage level corresponds to a sum of the output voltage and the first comparison voltage, the first amplifier being configured to output a second comparison voltage through an output terminal of the first amplifier; and
a second resistor circuit having one end connected to the output terminal of the first amplifier and having the other end connected to an output terminal of the calibration circuit, the second resister circuit being configured to output the sensing voltage by adjusting a third comparison voltage, and the third comparison voltage being generated by filtering the second comparison voltage, and
wherein the first resistor circuit having one end connected to the first input terminal of the first amplifier and having the other end connected to the output terminal of the first amplifier.

6. The power circuit of claim 5,
wherein the first resistor circuit comprises:
a plurality of pull-up resistors connected in series between the first input terminal of the first amplifier and the output terminal of the first amplifier; and
a plurality of pull-up switches connected in parallel to the plurality of pull-up resistors, respectively, each pull-up switch being configured to be turned on or off in response to the second control signal.

7. The power circuit of claim 6,
wherein the controller outputs the second control signal for turning on at least one of the plurality of pull-up switches to the first resistor circuit, based on an increase ratio of the first comparison voltage by the first resistor circuit.

8. The power circuit of claim 5,
wherein the second resistor circuit comprises:
a plurality of pull-down resistors connected in series between the output terminal of the first amplifier and a ground node; and
a plurality of pull-down switches, each pull-down switch being connected between one end of a corresponding one of the plurality of pull-down resistors and an output terminal of the calibration circuit.

9. The power circuit of claim 8,
wherein the controller outputs the first control signal for turning on one of the plurality of pull-down switches to the second resistor circuit, based on a reduction ratio of the third comparison voltage by the second resistor circuit.

10. The power circuit of claim 5,
wherein the calibration circuit further comprises:
a second amplifier having a first input terminal connected to an output terminal of the first amplifier and having a second input terminal connected to an output terminal of the second amplifier;
a first filter capacitor having one end connected to the output terminal of the first amplifier and having the other end connected to a ground node; and
a second filter capacitor having one end connected to the output terminal of the second amplifier and having the other end connected to the ground node.

11. The power circuit of claim 1,
wherein the comparison circuit comprises a comparator configured to receive the sensing voltage through a first input terminal thereof, receive the reference voltage through a second input terminal thereof, receive the output voltage through a third input terminal thereof, and output the comparison signal through an output terminal thereof.

12. The power circuit of claim 11,
wherein the comparison signal has a first value when a value obtained by subtracting the reference voltage and the output voltage from the sensing voltage is greater than 0, and a second value when the value obtained by subtracting the reference voltage and the output voltage from the sensing voltage is less than or equal to 0.

13. The power circuit of claim 12,
wherein the controller outputs the first control signal for reducing a voltage adjustment ratio of the second resistor circuit to the second resistor circuit when the comparison signal is the first value, and
wherein the controller outputs the second control signal for increasing a resistance of the first resistor circuit to the first resistor circuit when the comparison signal is the second value.

14. (canceled)

15. An operating method of a power circuit, the method comprising:
applying an input voltage to an input node;
converting the input voltage by using a voltage conversion circuit comprising an inductor and outputting an output voltage to an output node;
outputting, by using a sensing circuit, a first comparison voltage corresponding to a direct current (DC) component of an inductor current supplied to the inductor;
outputting a sensing voltage by adjusting the first comparison voltage by using a calibration circuit comprising a first resistor circuit and a second resistor circuit;
generating a comparison signal, based on the sensing voltage, a reference voltage, and the output voltage, by using a comparison circuit; and
outputting, by using a controller, a first control signal for adjusting a voltage adjustment ratio of the second resistor circuit to the second resistor circuit and a second control signal for adjusting a resistance of the first resistor circuit to the first resistor circuit, based on the comparison signal.

16. The method of claim 15,
wherein the outputting of the sensing voltage comprises:
outputting a second comparison voltage by adjusting the first comparison voltage by using the first resistor circuit; and
outputting the sensing voltage by adjusting a third comparison voltage by using the second resistor circuit, the third comparison voltage being generated by filtering the second comparison voltage.

17. The method of claim 15,
wherein the comparison signal has a first value when a value obtained by subtracting the reference voltage and the output voltage from the sensing voltage is greater than 0, and a second value when a value obtained by subtracting the reference voltage and the output voltage from the sensing voltage is less than 0.

18. The method of claim 17,
wherein the outputting of the second control signal to the first resistor circuit and the first control signal to the second resistor circuit comprises:
outputting the first control signal for reducing a voltage adjustment ratio of the second resistor circuit to the second resistor circuit when the comparison signal is the first value; and
outputting the second control signal for increasing a resistance of the first resistor circuit to the first resistor circuit when the comparison signal is the second value.

19. A power circuit comprising:
a voltage conversion circuit comprising an inductor, a first resistor, a first capacitor, and a second resistor, the voltage conversion circuit being configured to convert an input voltage applied to an input node and output an output voltage to an output node;
a sensing circuit comprising a third resistor, a second capacitor, a fourth resistor, and a third capacitor, the sensing circuit being configured to output a first comparison voltage corresponding to a direct current (DC) component of an inductor current supplied to the inductor;
a calibration circuit comprising a fifth resistor, a first amplifier, a first resistor circuit, and a second resistor circuit, the calibrating circuit being configured to adjust the first comparison voltage and output a sensing voltage;
a comparison circuit comprising a comparator, the comparison circuit being configured to generate a comparison signal, based on the sensing voltage, a reference voltage, and the output voltage; and
a controller configured to output a first control signal for adjusting a voltage adjustment ratio of the second resistor circuit to the second resistor circuit and a second control signal for adjusting a resistance of the first resistor circuit to the first resistor circuit, based on the comparison signal.

20-24. (canceled)

25. The power circuit of claim 19,
wherein the comparator receives the sensing voltage through a first input terminal thereof, receives the reference voltage through a second input terminal thereof, receives the output voltage through a third input terminal thereof, and outputs the comparison signal through an output terminal thereof,
wherein the comparison signal has a first value when a value obtained by subtracting the reference voltage and the output voltage from the sensing voltage is greater than 0, and a second value when the value obtained by subtracting the reference voltage and the output voltage from the sensing voltage is less than 0.

26. The power circuit of claim 25,
wherein the controller is configured to output:
the first control signal for reducing a voltage adjustment ratio of the second resistor circuit to the second resistor circuit when the comparison signal is the first value, and
the second control signal for increasing a resistance of the first resistor circuit to the first resistor circuit when the comparison signal is the second value.
